(19) United States
(12) Patent Application Publication
(10) Pub. No.: US 2021/0009849 A1
(43) Pub. Date: Jan. 14, 2021

(54) EYEWEAR COMPRISING AN OPHTHALMIC LENS HAVING AN EDGE COATING

(71) Applicant: Essilor International, CHARENTON-LE-PONT (FR)

(72) Inventors: Mabeline TAN, Singapore (SG); Hui YU, Singapore (SG); Prakhar KASTURE, Singapore (SG)

(21) Appl. No.: 16/981,485

(22) PCT Filed: Mar. 19, 2019
(86) PCT No.: PCT/EP2019/056882

§ 371 Date: Sep. 16, 2020

(30) Foreign Application Priority Data
Mar. 20, 2018 (EP) 18305309.9

(51) Int. Cl. C09D 175/04; G02B 1/10; C09D 5/00; C09D 7/61

(52) U.S. Cl. CPC C09D 175/04; G02B 1/10; G02C 7/02; C09D 7/61; C09D 5/00

(57) ABSTRACT

An eyewear comprising an ophthalmic lens is provided. The ophthalmic lens comprises a first optical surface and an opposing second optical surface, wherein the first optical surface and the second optical surface are connected by an edge surface. A coating material is disposed on the edge surface of the ophthalmic lens as an edge coating. The edge coating has a refractive index n1 and the ophthalmic lens has a refractive index n2, wherein a) n1 is greater than or equal to n2, or b) n1 is less than n2, and (n2−n1) is 0.4 or less. A method of preparing a coating material for forming an edge coating on an edge surface of an ophthalmic lens, a method of coating an edge surface of an ophthalmic lens, and use of a coating material to coat an edge surface of an ophthalmic lens are also provided.

### TECHNICAL FIELD

This disclosure relates generally to an eyewear comprising ophthalmic lenses having an edge coating, methods of preparing a coating material for the edge coating, and methods of manufacturing an eyewear and coating an edge surface of an ophthalmic lens.

### BACKGROUND

A coating material may be introduced on the edge of an ophthalmic lens as an edge coating for various reasons. For example, an opaque coating may be deposited on the edge of an ophthalmic lens to reduce visibility of myopia rings and white rings for aesthetic purposes. Examples of a myopia ring and a white ring are shown in FIG. 1A and FIG. 1B as 110 and 112, respectively. For effective reduction in visibility of the myopia rings and white rings, the edge coating should have good opacity, finishing, mechanical, and adhesion properties to allow masking of the myopia rings and white rings.

To this end, an operator may apply the coating material on the edge of an ophthalmic lens using a marker pen or a brush, or by spray coating. Ideally, the coating material is applied onto the edge surface of the ophthalmic lens only, without any of the coating material being coated on the optical surfaces of the ophthalmic lens.

For illustration purposes, FIG. 2A is a schematic diagram showing an edge coating 202 disposed on an edge surface of an ophthalmic lens 200. The edge surface of the ophthalmic lens 200 is defined by the surface connecting the first optical surface 220 and the second optical surface 222. The edge surface of the ophthalmic lens 200 comprises a lens bevel 226 and a safety bevel 224. As depicted in the figure, there is no overflow on the first optical surface 220 and the second optical surface 222 of the ophthalmic lens 200.

Notwithstanding the above, the operator often finds himself or herself in a situation whereby he or she accidentally introduces some excess coating, otherwise termed herein as overflow, on the optical surfaces. This is depicted in FIG. 2B, which is a schematic diagram showing an edge coating 202 disposed on an edge surface of an ophthalmic lens 200. As shown in the figure, there is overflow in the form of excess coating material 204, 206 disposed respectively on the first optical surface 220 and the second optical surface 222 of the ophthalmic lens 200. These overflows have to be removed completely so as not to compromise aesthetics of the ophthalmic lens. In embodiments wherein an ophthalmic lens edge comprises multiple facets, for example, it is very difficult to ensure complete coating coverage on each and every facet, while not introducing overflows on the optical surfaces.

Accordingly, apart from the good opacity, finishing, mechanical, and adhesion properties mentioned above, it is also important that the coating material allows ease of removal in the event of overflow. Furthermore, the coating material should cure in shorter spans of time such as within 6 hours, so as to allow mounting of lenses as soon as possible after applying the coating material.

In light of the above, there remains a need for improved coating materials which are able to provide a consistent and complete coating coverage on the edge surface of an ophthalmic lens, and which address or at least alleviate one or more of the above-mentioned problems.

### SUMMARY

In a first aspect, an eyewear comprising an ophthalmic lens is provided. The ophthalmic lens comprises a first optical surface and an opposing second optical surface, wherein the first optical surface and the second optical surface are connected by an edge surface. A coating material is disposed on the edge surface of the ophthalmic lens as an edge coating, wherein the edge coating has a refractive index n₁ and the ophthalmic lens has a refractive index n₂, and wherein a) n₁ is greater than or equal to n₂, or b) n₁ is less than n₂, and (n₂−n₁) is 0.4 or less. Other advantageous features are described in claims 2 to 8.

In a second aspect, a method of preparing a coating material for forming an edge coating on an edge surface of an ophthalmic lens is provided. The method comprises providing a solution comprising two or more polyols, adding an opacity agent, an isocyanate cross-linking agent, and a catalyst to the solution, wherein the isocyanate cross-linking agent is added after the opacity agent is added to the solution, and cross-linking the two or more polyols with the isocyanate cross-linking agent to form a matrix material, wherein the opacity agent is dispersed in the matrix material. Methods according to the invention are described in claims 9 to 11.

In a third aspect, a method of coating an edge surface of an ophthalmic lens is provided. The method comprises providing an ophthalmic lens comprising a first optical surface and an opposing second optical surface, wherein the first optical surface and the second optical surface are connected by an edge surface, and disposing a coating material on the edge surface of the ophthalmic lens as an edge coating, wherein the edge coating has a refractive index n₁ and the ophthalmic lens has a refractive index n₂, and wherein a) n₁ is greater than or equal to n₂, or b) n₁ is less than n₂, and (n₂−n₁) is 0.4 or less.

In a fourth aspect, use of a coating material having a refractive index n₁ to coat an edge surface of an ophthalmic lens having a refractive index n₂, wherein a) n₁ is greater than or equal to n₂, or b) n₁ is less than n₂, and (n₂−n₁) is 0.4 or less, is provided.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1A is a photograph showing front view of a user wearing an eyeglass 100. A white ring 112 is shown.

FIG. 1B is a photograph showing side view of a user wearing an eyeglass 100. A white ring 112 and a myopia ring 114 is shown.

FIG. 2A is a schematic diagram showing an edge coating 202 disposed on an edge surface of an ophthalmic lens 200 according to an embodiment. The edge surface of the ophthalmic lens 200 is defined by the surface connecting the first optical surface 220 and the second optical surface 222. The first optical surface 220 and the second optical surface 222 may respectively be a concave (Cc) surface and a convex (Cx) surface of the ophthalmic lens 200. The edge surface of the ophthalmic lens 200 comprises a lens bevel 226 and a safety bevel 224. As depicted in the figure, there is no overflow on the first optical surface 220 and the second optical surface 222 of the ophthalmic lens 200.

FIG. 2B is a schematic diagram showing an edge coating 202 disposed on an edge surface of an ophthalmic lens 200 according to an embodiment. The edge surface of the ophthalmic lens 200 is defined by the surface connecting the first optical surface 220 and the second optical surface 222. The first optical surface 220 and the second optical surface 222 may respectively be a concave (Cc) surface and a convex (Cx) surface of the ophthalmic lens 200. The edge surface of the ophthalmic lens 200 comprises a lens bevel 226 and a safety bevel 224. As depicted in the figure, there is overflow in the form of excess coating material 204, 206 disposed respectively on the first optical surface 220 and the second optical surface 222 of the ophthalmic lens 200.

FIG. 3A is a photograph showing an ophthalmic lens 300. As depicted in the figure, the profile of the edge surface includes a step-back 360 along a perimeter portion of one or both of the first optical surface and the second optical surface.

FIG. 3B is a schematic diagram showing a cross-section of the ophthalmic lens 300 of FIG. 3A along line A-A′. The step-back 360 is shown as a “L” shape with reference to the edge surface and the optical surface of the ophthalmic lens 300.

FIG. 4 is a graph showing aesthetic performance of edge coatings by commercial products in comparison to a coating material according to an embodiment disclosed herein (Coating 434). All of the coatings tested were black in colour. The performance was assessed based on four characteristics, namely, (A) whether there was fading of coloured edge over time, (B) whether the ophthalmic lens with the edge coating was free of myopia rings, (C) whether the ophthalmic lens with the edge coating was free of white rings, and (D) whether the coloured edge (CE) finishing was uniform, with all areas covered by the coating. A rating ranging from Grade 1 to Grade 5 was then accorded to the coatings, with Grade 1 being the worst performance and Grade 5 being the best performance. Grade 0 is the rating according to a bare surface without any edge coating. Coatings 431, 432, and 433 were three commercially available products used, whereby the myopia rings were not masked entirely as compared to Coating 434, which is an edge coating according to an embodiment. The masking performance of the coatings are shown in FIG. 5. All the coatings were made on an edge surface of an ophthalmic lens having a refractive index of 1.56.

FIG. 5 are photographs showing finishing of coloured edge of commercial product and an edge coating according to an embodiment disclosed herein. As shown in the figure, 531 and 533, corresponding to Coatings 431 and 433 respectively in FIG. 4, have a rating of Grade 1 and 3, respectively, while the edge coating according to an embodiment 534, corresponding to Coating 434 in FIG. 4, has a rating of Grade 4.

FIG. 6 is a schematic diagram of a coating material preparation procedure according to an embodiment. In a first step 641, a first polyol and a solvent are mixed to form a first solution, which may be carried out at room temperature for a time period of about 2 to 3 hours or until the first polyol dissolves completely. At the same time, a second polyol and a co-solvent are mixed in a second step 642 to form a second solution, which may be carried out at a temperature of about 50° C. for a time period of about 2 to 4 hours or until the second polyol dissolves completely. The first solution and the second solution are mixed in a third step 643, which may be carried out under stirring for 2 to 3 hours. An opacity agent is added in a fourth step 644 to the resultant mixture and mixed, which may be carried out under stirring for about 0.5 to 1 hour. An isocyanate cross-linking agent is then added in a fifth step 645 to the mixture and mixed, which may be carried out under stirring for about 15 to 20 minutes. A catalyst is then added in a sixth step 646 to the mixture and mixed, which may be carried out under stirring for about 10 minutes. The catalyst can also be added before the isocyanate cross-linking agent is added. A dispersion containing the coating material is obtained, which may be used for coating application on edge surface of an ophthalmic lens.

FIG. 7 are photographs depicting performance comparison of myopia ring masking by an edge coating according to an embodiment against commercial products. In the figure, Grade 1 and Grade 3 is rated for two commercial products corresponding to Coatings 431 and 432 respectively in FIG. 4. The edge coating according to an embodiment (corresponding to Coating 434 in FIG. 4) has demonstrated a rating of Grade 5.

FIG. 8 are photographs depicting performance of white ring masking of an edge coating according to an embodiment disclosed herein against commercial products. In the figure, Grade 3 is rated for a commercial product corresponding to Coating 432 in FIG. 4. The edge coating according to an embodiment (corresponding to Coating 434 in FIG. 4) has demonstrated a rating of Grade 5, which may be attributed to a combination of adhesion, flow ability, and viscosity properties of the coating material. Grade 0 has been defined for lenses with absolutely no coatings, displaying 100% of white rings.

FIG. 9 are photographs depicting performance comparison of coloured edge finishing of edge coatings according to embodiments disclosed herein against commercial products. In the figure, Grade 1 and 3 are commercial products corresponding to Coatings 431 and 432 in FIG. 4. Grades 4 and 5 are edge coatings according to embodiments, whereby the Grade 4 edge coating corresponds to Coating 434 in FIG. 4. A rating of Grade 1 was given for Coating 431 as it had grey/white irregular patches of regions visible on 50% or more of the edge surface. A rating of Grade 2 was given if the coating had grey/white irregular patches of regions visible on 30% or more of the edge surface as shown in the figure. A rating of Grade 3 was given for Coating 432 as it had small regions of non-homogeneous grey areas which may not be regular. A rating of Grade 4 was given for an exemplified coating according to an embodiment as it had perfectly black coverage except for two faint and regular grey/white lines. A rating of Grade 5 was given for a further exemplified coating according to an embodiment as it had total coverage of the edge surface giving a perfectly black area. The different grades of Grades 4 and 5 in the edge coatings mentioned above may be achieved by varying adhesion properties, drying time, viscosity, flow ability, opacity, and/or thickness of the coating. To achieve Grade 5, smaller particle sizes as compared to that used in Grade 4 were used. Particles with a smaller size may refer to particles having a size of less than about 0.5 microns.

FIG. 10 depicts examples of lens edge profiles.

FIG. 11 is a schematic diagram depicting incident light at an interface of an ophthalmic lens having a refractive index n₂ and an edge coating having a refractive index n₁, whereby n₁ is equal to n₂, i.e. n₁=n₂, according to embodiments.

FIG. 12 is a graph depicting relationship between critical angle and delta refractive index (RI), defined as difference between refractive index of an ophthalmic lens and refractive index of an edge coating, according to embodiments.

FIG. 13 is a schematic diagram depicting incident light at an interface of an ophthalmic lens having a refractive index n₂ and an edge coating having a refractive index n₁, whereby n₁ is smaller than n₂, i.e. n₁<n₂, according to embodiments.

FIG. 14 is a schematic diagram depicting incident light at an interface of an ophthalmic lens having a refractive index n₂ and an edge coating having a refractive index n₁, whereby n₁ is greater than n₂, i.e. n₁>n₂, according to embodiments.

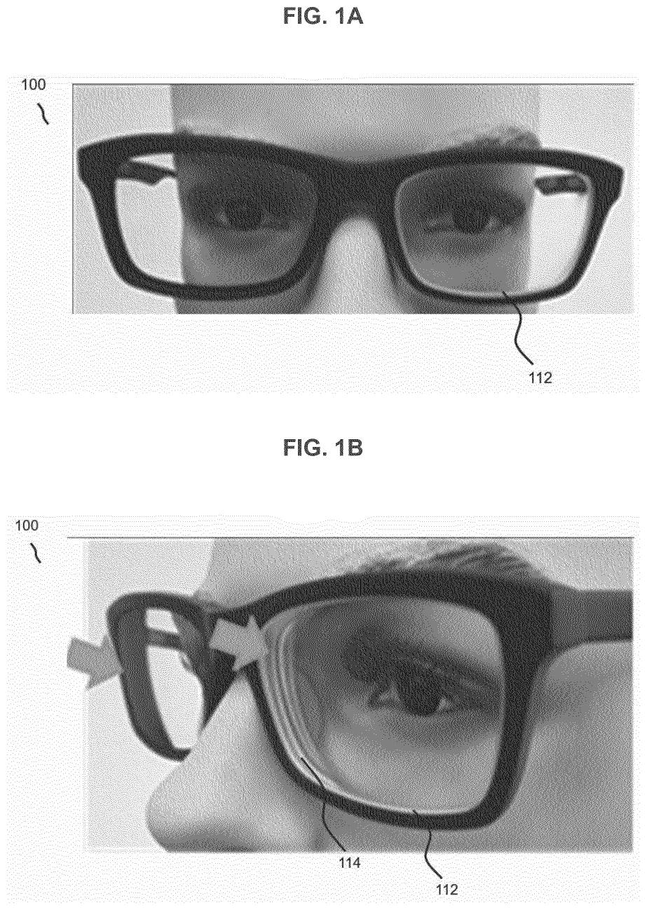

### DETAILED DESCRIPTION

In the description which follows, the drawing figures are not necessarily to scale and certain features may be shown in generalized or schematic form in the interest of clarity and conciseness or for informational purposes. In addition, although making and using various embodiments are discussed in detail below, it should be appreciated that as described herein are provided many inventive concepts that may be embodied in a wide variety of contexts. Embodiments discussed herein are merely representative and do not limit the scope of the invention.

Various embodiments disclosed herein relate to a coating material for deposition on an edge surface of an ophthalmic lens, and which has demonstrated high opacity and a good finishing of coloured edge, thereby eliminating or reducing visibility of myopia rings and white rings on the lens for aesthetic purposes. Advantageously, improvement in aesthetics of the lens was demonstrated regardless of the type of colourant, otherwise termed herein as opacity agent, contained in the coating material. A coating material disclosed herein is able to provide high opacity using only a single coat application, which is sufficient to hide myopia rings as well as white rings. It also allowed easy removal of an overflow on one or both the first optical surface and the second optical surface of the ophthalmic lens.

With the above in mind, various embodiments refer in a first aspect to an ophthalmic lens comprising a first optical surface and an opposing second optical surface, wherein the first optical surface and the second optical surface are connected by an edge surface. A coating material is disposed on the edge surface of the ophthalmic lens as an edge coating. The edge coating has a refractive index n₁ and the ophthalmic lens has a refractive index n₂, and wherein a) n₁ is greater than or equal to n₂, or b) n₁ is less than n₂, and (n₂−n₁) is 0.4 or less.

As used herein, the term “ophthalmic lens” refers to any type of lens intended to be supported by a wearer's face, which may be for purposes of improving or enhancing visual acuity, for protecting against the environment, for fashion, or for adornment. The term may refer to ophthalmic lenses, such as non-corrective lenses, semi-finished lens blanks, and corrective lenses, such as progressive addition lenses, unifocal or multifocal lenses. The term may also include one or more of prescription, non-prescription, reflective, anti-reflective, magnifying, polarizing, filtering, anti-scratch, coloured, tinted, clear, anti-fogging, ultraviolet (UV) light protected, or other lenses. Further examples of ophthalmic lens include electronic lens, virtual reality (VR) lens, and the like.

An ophthalmic lens is generally manufactured in accordance with wearer specifications from an ophthalmic lens blank such as a semi-finished lens blank. A semi-finished lens blank generally has two opposite surfaces at least one of which is unfinished. The unfinished surface of the lens blank may be machined according to the wearer's prescription to provide the required surface of the ophthalmic lens. An ophthalmic lens having finished back and front surfaces may be referred to as an uncut ophthalmic lens. In the case of an ophthalmic lens for the correction or improvement of eyesight, for example, the ophthalmic lens may be manufactured according to a wearer prescription corresponding to the visual requirements of that wearer. At least one of the surfaces of the ophthalmic lens may be processed to provide an ophthalmic lens according to the wearer prescription.

The shape and size of the spectacle frame supporting the ophthalmic lens may also be taken into account. For example, the contour of the uncut ophthalmic lens may be edged according to a shape of a spectacle frame on which the ophthalmic lens is to be mounted in order to obtain an edged or cut ophthalmic lens.

The ophthalmic lens according to embodiments disclosed herein comprises a first optical surface and an opposing second optical surface, wherein the first optical surface and the second optical surface are connected by an edge surface.

As mentioned above, ophthalmic lens may be manufactured in accordance with wearer specifications and which may be processed to provide the ophthalmic lens with various functions. Accordingly, ophthalmic lens may have a complex structure resulting from interlayering of materials and/or a series of treatments to tailor the ophthalmic lens to specific user requirements. For example, the treatments may be carried out to reduce thickness and to render the ophthalmic lens lightweight, to improve on transparency, for durability, strength and protection, aesthetics etc. It follows that an ophthalmic lens may comprise one or more coatings disposed on a surface of a substrate functioning as an optical surface, such as an anti-breakage coating, an anti-scratch coating, an anti-reflection coating, a tint coating, a colour coating, an anti-static coating, or an anti-smudge coating.

Accordingly, the term “optical surface” as used herein refers to surface of a substrate in the form of a bare ophthalmic lens without any coating disposed on the optical surface(s), such as an unfinished or untreated ophthalmic lens, as well as surface of a coating which may be designed to be temporarily or permanently disposed on the optical surface(s) of a bare ophthalmic lens. Examples of a coating that may be disposed on an ophthalmic lens have already been mentioned above, and may further include, but are not limited to, (1) topcoat, (2) anti-reflective (AR) coatings and asymmetrical mirrors, and/or (3) hardcoat (HC).

In various embodiments, the first optical surface and the second optical surface may independently be a substrate, a substrate having a hard coat, or a substrate having a hard multi-coat (HMC) coating, i.e. an antireflective (AR) coating, a hardcoat (HC), and a topcoat disposed thereon. In various embodiments, the first optical surface and the second optical surface may respectively be a concave (Cc) surface and a convex (Cx) surface of the ophthalmic lens.

The first optical surface and the second optical surface are connected by an edge surface. As used herein, the term “edge surface” refers to a lateral flank and/or external contour of an ophthalmic lens. For example, the edge surface may define a surface on the lateral flank and/or external contour of an ophthalmic lens upon which a coating material is to be disposed. The edge surface may include a lens bevel and a safety bevel. The term “lens bevel” refers generally to the edge of a lens shaped like a “V”, and may help to secure the lens after it has been inserted in an eyewear frame. The term “safety bevel”, on the other hand, refers to a flattening bevel ground on the external contour of the ophthalmic lens, which may be formed at an interface between the external contour and the optical faces of the ophthalmic lens, whereby the sharp edges have been removed for a safer lens. The lens bevel and the safety bevel may constitute a profile on the edge surface.

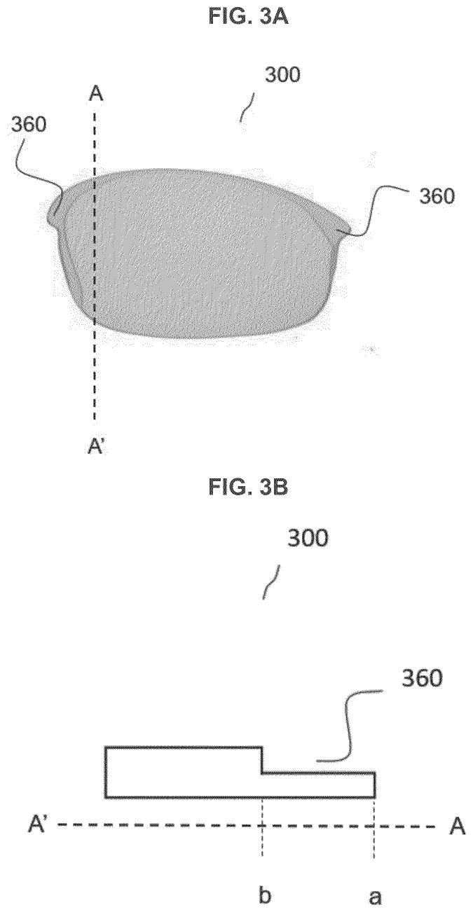

In some embodiments, the ophthalmic lens may further include a step-back on a perimeter portion of one or both of the first optical surface and the second optical surface abutting the edge surface. In such embodiments, the profile on the edge surface may include the step-back along with the lens bevel and the safety bevel. An example of a step-back is shown in FIG. 3A and FIG. 3B. As shown in the figures, the ophthalmic lens 300 includes a step-back 360 on an optical surface abutting the edge surface, which may be formed by removing a portion of a perimeter portion of the optical surface. Although the step-back 360 in FIG. 3B is shown as a “L” shape with reference to the edge surface and the optical surface of the ophthalmic lens 300, it may be of any other shapes such as a “C” shape, a staggered “L” shape, or an irregular shape, for example, with reference to the edge surface and the optical surface of the ophthalmic lens 300. The step-back portion may be used to retain the coating material with object of providing a desired coloured contour on the ophthalmic lens. For example, the step-back portion with the at least one coating material could provide a desired colored contour which looks like the rim of eyeglasses.

A coating material may be disposed on the edge surface of the ophthalmic lens as an edge coating. As mentioned above, the edge surface of the ophthalmic lens may be multi-faceted or comprise various shape profiles depending on specific requirements for the finished ophthalmic lens. The edge surface of an ophthalmic lens may, for example, comprise a lens bevel, a safety bevel, and/or a step-back. The coating material may accordingly be disposed on an entire portion of the edge surface, or on selected portions of the edge surface, such as on one or more facets of a multi-faceted edge surface, the lens bevel, the safety bevel, and/or the step-back. A different coating material may be disposed on selected portions of the edge surface. In various embodiments, the coating material may be disposed as one or more layers on the edge of an ophthalmic lens. In some embodiments, two or more layers of the coating material are present, and each of the one or more layers may comprise the same or a different coating material.

The coating material may be introduced on the edge of an ophthalmic lens as an edge coating for various reasons.

For example, the coating material may form a coating effective to reduce a reflection caused by a profile of the edge surface. As mentioned above, an opaque coating may be deposited on the edge of an ophthalmic lens to reduce or to prevent myopia rings and white rings for aesthetic purposes. Myopia rings may be caused by total internal reflection when light travels from the lens edge to the air gap between the lens and the frame, and may be generated due to reflection of light from one or both of the optical surfaces and/or the edge surface. This is particularly true at the lens edges, which, oftentimes, have been shaped in order to be fitted into the frame. White rings, on the other hand, may be caused by a thickness of the ophthalmic lens, and may be observed visually from the front of the lens. By reducing or eliminating a reflection caused by a profile of the edge surface, visibility of the myopia rings or white rings otherwise appearing along the perimeter of the ophthalmic lens face may be reduced or eliminated.

The reduction or elimination of reflection of light from one or both of the optical surfaces and/or the edge surface may be carried out, for example, by one or more of (i) absorbing incident light on the interface of an ophthalmic lens and an edge coating; (ii) increasing the transmittance of incident light on the interface of an ophthalmic lens and an edge coating; or (iii) increasing roughness of one or both of the optical surfaces and/or the edge surface.

To this end, it has been surprisingly found by the inventors that refractive index of edge coating may be used to control visibility of myopia rings. This may be achieved by using an edge coating having a refractive index n₁ which is greater than or equal to the refractive index of the ophthalmic lens n₂, or by using an edge coating having a refractive index n₁ which is less than n₂, and (n₂−n₁) is 0.4 or less. By varying the refractive indices of the edge coating and/or the underlying ophthalmic lens so as to meet the above conditions, light behavior through the lens may be altered to reduce visibility of myopia rings.

The term “refractive index” or “index of refraction” as used herein refers to the absolute refractive index of a material, which may be expressed as the ratio of the speed of electromagnetic radiation in free space, such as vacuum, to the speed of the electromagnetic radiation in that material. Refractive index may be measured using known methods using, for example, an Abbe refractometer in the visible light region.

In some embodiments, the refractive index of the edge coating and the refractive index of the ophthalmic lens are such that refractive index of the edge coating n₁ is the same or substantially similar to the refractive index of the ophthalmic lens n₂. By disposing an edge coating on an edge surface of the ophthalmic lens, any light passing through the ophthalmic lens is able to travel from the ophthalmic lens to the edge coating with minimal refraction and/or reflection, since the two refractive indices are the same or similar. In other words, any abrupt change in refractive index which would have been present at the interface between edge of the ophthalmic lens and air is now levelled by the edge coating, since any light passing through the ophthalmic lens does not encounter a substantial difference in refractive index between the ophthalmic lens and the edge coating. This translates into reduced visibility of myopia rings.

In some embodiments, the refractive index of the edge coating and the refractive index of the ophthalmic lens are such that refractive index of the edge coating n₁ is greater than the refractive index of the ophthalmic lens n₂. If the refractive index of the edge coating is higher than that of the lens, light may be able to pass from the lower index medium (lens) to higher index medium (edge coating) by regular refraction of light without experiencing total internal reflection. In this case, myopia rings may not be observed either.

In some embodiments, the refractive index of the edge coating and the refractive index of the ophthalmic lens are such that refractive index of the edge coating n₁ is less than the refractive index of the ophthalmic lens, and difference between the refractive index of the ophthalmic lens and the refractive index of the edge coating is 0.4 or less, such as 0.3 or less, 0.2 or less, 0.1 or less, or 0.05 or less. In some embodiments, the difference between the refractive index of the ophthalmic lens and the refractive index of the edge coating is 0.3 or less. In some embodiments, the difference between the refractive index of the ophthalmic lens and the refractive index of the edge coating is 0.2 or less. In some embodiments, the difference between the refractive index of the ophthalmic lens and the refractive index of the edge coating is 0.1 or less. In some embodiments, the difference between the refractive index of the ophthalmic lens and the refractive index of the edge coating is 0.05 or less. The smaller the difference in refractive index between the edge coating and the lens, there may be a lower propensity for total internal reflection to occur due to an increased critical angle, which translates into increased attenuation of myopia rings by the edge coating. Further details are provided in Example 9 of the experimental section below.

Since the refractive index of the edge coating n₁ and the refractive index of the ophthalmic lens n₂ are expressed relative to each other, it follows that the respective refractive indices are determined under the same or similar conditions such as wavelength of incident light, in establishing the various relationships between n₁ and n₂ mentioned herein.

In various embodiments, the refractive index of the edge coating may be in the range from about 1.4 to less than about 2. For example, refractive index of the edge coating may be in the range of about 1.4 to about 1.99, such as about 1.5 to about 1.99, about 1.6 to about 1.99, about 1.7 to about 1.99, about 1.8 to about 1.99, about 1.4 to about 1.9, about 1.4 to about 1.8, about 1.4 to about 1.7, about 1.4 to about 1.6, about 1.45 to about 1.85, about 1.45 to about 1.75, or about 1.5 to about 1.7. Refractive index of the ophthalmic lens, on the other hand, may be in the range from about 1.4 to about 1.9, such as about 1.5 to about 1.9, about 1.6 to about 1.9, about 1.7 to about 1.9, about 1.8 to about 1.9, about 1.4 to about 1.8, about 1.4 to about 1.7, about 1.4 to about 1.6, about 1.45 to about 1.85, about 1.45 to about 1.75, or about 1.5 to about 1.7. Ophthalmic lens material having a refractive index towards the lower range may include allyl diglycol carbonate (CR39), polycarbonate (PC), Acrylic, Trivex, and/or a thiourethane-based material such as MR8, while ophthalmic lens material having a refractive index towards the higher range may include a thiourethane-based material such as MR7, a 1.74 substrate, and/or glass.

Notwithstanding the above, it is possible to modify the coating material to increase refractive index of the coating material, for example, by doping with a material having a high refractive index, such as metal oxide. For example, rutile or titanium oxide (TiO₂) has a high refractive index of about 2.7, and may be used to dope a coating material, such that refractive index of the doped coating material is equal to or greater than the refractive index of the lens. This may apply for embodiments in which the lens has a high refractive index of greater than 1.6, such as greater than 1.65, greater than 1.7, or greater than 1.74, such that by doping a coating material having a relatively lower refractive index of 1.4 with the material having a high refractive index of 2.7, it may be possible to increase refractive index of the coating material to 1.6 or more.

Other factors, such as type of coating method, thickness of the edge coating, and colour of the coating (in cases wherein a non-black coating is used), may also be controlled to alter attenuation of light and hence alter the effectiveness of the edge coating.

In the embodiments described above, the edge coating may be a translucent coloured coating, which allows some light to pass through thereby camouflaging or disguising the myopia rings or white rings. In various embodiments, the edge coating may be an opaque or almost opaque, which allows the edge coating to absorb at least part of, if not all, of the light arriving from the lens, which may result in further attenuation of the light.

The opaque coating may have a colour that can be user specified. For example, the colour of the opaque coating may be chosen to be the same as or to complement with colour of an eyewear frame with which the ophthalmic lens is fitted. The colour of the opaque coating may alternatively be chosen to contrast with the colour of the eyewear frame, thereby giving the wearer an additional fashion choice while providing the benefits of reducing the appearance of the myopia ring or white ring appearing along the perimeter of the ophthalmic lens face. In this regard, the coating material may function as a material effective to provide an aesthetic effect to the edge surface. The opaque coating may alternatively be in skin color that is adapted to the wearer's skin. Alternatively, examples of the materials also include photochromic or thermochromic materials.

The opacity of the coating material may be imparted from an opacity agent contained in the coating material.

As used herein, the term “opacity agent” refers to a substance or an additive added to a material so as to reduce transparency or light transmittance through the material. In this regard, the material may function as a matrix for holding the opacity agent, and the opacity agent may be dispersed in the matrix. The opacity agent may include, but is not limited to, pigments, carbon black, titanium dioxide, calcium oxide, beryllium oxide, and/or a combination thereof.

In various embodiments, the opacity agent comprises or consists of a pigment. The pigment may be light absorbing, such as in the case of a black pigment. In some embodiments, the opacity agent comprises or consists of carbon black.

The opacity agent may be dispersed in a matrix material. The term “matrix material” as used herein refers to any support, which may be liquid, semi-solid, or solid, for carrying the opacity agent and/or other components of the coating material. In various embodiments, the opacity agent is dispersed at least substantially homogeneously in the matrix material.

The matrix material may include, but is not limited to, a UV-curable composition such as acrylate, epoxy, unsaturated polymer, silane, styrene, vinyl chloride, vinyl acetate, a thermal-curable composition such as polyurethane (of which nitrocellulose modified polyurethane is one example), polyurea, epoxy, polyester, polyamide, polyimide, polyether, alkyd, polycarbonate, or a combination thereof. The various combinations of matrix material and opacity agent disclosed herein are examples of materials effective to reduce a reflection caused by a profile of the edge surface. In specific embodiments, the matrix material is a cross-linked polyurethane.

Weight ratio of the matrix material to the opacity agent may be in the range of about 1:0.05 to about 1:3, such as about 1:0.1 to about 1:3, about 1:0.5 to about 1:3, about 1:1 to about 1:3, about 1:1.5 to about 1:3, about 1:2 to about 1:3, about 1:2.5 to about 1:3, about 1:0.05 to about 1:2.5, about 1:0.05 to about 1:2, about 1:0.05 to about 1:1.5, about 1:0.05 to about 1:1, about 1:0.05 to about 1:0.5, about 1:0.05 to about 1:0.1, about 1:0.5 to about 1:2.5, or about 1:1 to about 1:2.

In various embodiments, the edge coating has one or more of: a) a transmittance of less than 5%; b) an adhesion strength in the range of about 1 N/mm² to about 5 N/mm²; c) a pencil hardness in the range of about 1H to about 4 H.

In various embodiments, the edge coating has a transmittance of less than 5%, such as less than 4%, less than 3%, less than 2%, less than 1%, or a transmittance in the range of 1% to 5%, 2% to 5%, or 3% to 5%. The term “transmittance” as used herein refers to intensity of radiation transmitted through a material over that of the incident radiation, and which is expressed as a percentage. As mentioned above, the edge coating may be opaque or almost opaque, which allows the edge coating to absorb at least part of, if not all, of the light arriving from the lens, so as to result in further attenuation of the light. The transmittance may be measured across the visible light region of the electromagnetic spectrum, corresponding to a wavelength range of about 350 nm to about 750 nm.

In various embodiments, the edge coating has an adhesion strength in the range of about 1 N/mm² to about 5 N/mm². A coating material having an adhesion strength that is too low may not be able to remain adhered on the edge surface of the ophthalmic lens upon further processing, for example, when mounting the ophthalmic lens onto a frame or when removing overflow from the optical surface(s). This may result in chipping of the edge coating. On the other hand, when adhesion strength of the coating material is too high, it may be difficult to remove any overflow from the optical surface(s) of the ophthalmic lens. To this end, the present inventors have found that an adhesion strength in the range of about 1 N/mm² to about 5 N/mm² provides optimal balance of adhesive properties to allow adhering to the edge surface, while still rendering it possible to easily remove any overflow from the optical surface(s) of the ophthalmic lens.

In various embodiments, the edge coating has a pencil hardness in the range of about 1 H to about 4 H. As used herein, the term “pencil hardness” refers to a hardness value which is measured according to American Society of Testing Material ASTM D-3363, and may be a measure of the resistance of the coating material to superficial scratches. A coating material having a pencil hardness that is too low may result in scratching of the coating material during processing, for example, when mounting the ophthalmic lens onto a frame. On the other hand, a coating material having a pencil hardness that is too high may result in an edge coating that is too brittle. The inventors have found that a pencil hardness in the range of about 1 H to about 4 H provides a good balance of durability of the edge coating and processability of the coating material during processing.

In addition to the above-mentioned, the coating material may function as (a) a lubricating material effective to ease mounting of the ophthalmic lens onto an eyeglass frame, and/or (b) a shock absorbing material effective to reduce stress concentrations on an edge portion of the ophthalmic lens.

For functioning as a lubricating material effective to ease mounting of the ophthalmic lens onto an eyeglass frame, the coating material may further comprise a lubricating substance, such as a lubricating fluid, for example, a synthetic oil or a lubricity enhancing polyfluoropolyether fluid, and/or a lubricating grease. The lubricating substance may be dispersed in the coating material, or be applied as a layer on the edge coating formed by the coating material.

The coating material may function as a shock absorbing material effective to reduce or prevent stress concentrations on an edge portion of the ophthalmic lens. For functioning as a shock absorbing material, the coating material may further comprise a shock absorbing substance such as carbon black, iron oxide and/or a metallic oxide. As carbon black, which serves as an opacity agent, is also able to function as a shock absorbing substance, in embodiments wherein the opacity is carbon black, the coating material may already be able to function as a shock absorbing material without further addition of a shock absorbing substance.

Various embodiments refer in a second aspect to a method of preparing a coating material for forming an edge coating on an edge surface of an ophthalmic lens. The method may comprise providing a solution comprising two or more polyols.

The two or more polyols may be selected from the group consisting of a dendritic polyol, a polyacrylic polyol, a polyether polyol, a polycarbonate polyol, a benzoxazine polyol, a polyester polyol, and a combination thereof.

The two or more polyols may be dissolved in a suitable solvent, such as acetone, propylene glycol monomethyl ether acetate, 1-methoxy-2-propanol acetate, or a combination thereof. In various embodiments, the solvent comprises acetone and propylene glycol monomethyl ether acetate. Amount of the solvent may be varied to control viscosity of the resulting coating material. This may be carried out to reduce variation in thickness of the edge coating, as high viscosity may be used to minimize flowability thereby allowing the coating material to stick on the edge surface.

In various embodiments, the solution comprises a first polyol and a second polyol. The first polyol may comprises or consists of dendritic polyol, while the second polyol may comprise or consist of polycaprolactone-based polyol. Advantageously, dendritic polyol contains multiple reactive sites, which may be used to react with an isocyanate cross-linking agent to form highly crosslinked polyurethane, which imparts the coating material with desired properties as demonstrated herein. Both the dendritic polyol and the polycaprolactone-based polyol may provide adhesion properties and result in a reduced drying time of the resultant coating material. Additionally, the dendritic polyol is able to provide a suitable refractive index to the coating materials so as to match the refractive index of the coating materials to the refractive index of substrates. The polycaprolactone-based polyol is also able to impart good mechanical properties to the edge coating, and may help to prevent leaching of opacity agent from the coating material.

The first polyol may be present in a greater amount as compared to the second polyol. Weight ratio of the first polyol to the second polyol may, for example, be in the range of about 1:0.1 to about 1:0.5, such as about 1:0.2 to about 1:0.5, about 1:0.3 to about 1:0.5, about 1:0.1 to about 1:0.4, about 1:0.1 to about 1:0.3, or about 1:0.2 to about 1:0.4.

An opacity agent, an isocyanate cross-linking agent, and a catalyst may be added to the solution. The isocyanate cross-linking agent may be added after the opacity agent is added to the solution to allow the opacity agent to be dispersed more homogenously in the solution before cross-linking takes place. Order of adding the catalyst, on the other hand, is not particularly important and may be added with the opacity agent and/or the isocyanate cross-linking agent.

Examples of suitable opacity agent have already been discussed above.

The isocyanate cross-linking agent may be selected from the group consisting of hexamethylene isocyanate dimer or trimer, isophorone diisocyanate, toluene diisocyanate, methylene diphenyl diisocyanate and other aliphatic or aromatic diisocyanate, and a combination thereof. In some embodiments, the isocyanate cross-linking agent is hexamethylene isocyanate trimer.

The isocyanate cross-linking agent may be added in an amount, such that molar ratio of the at least two polyols to the isocyanate cross-linking agent is in the range of about 1:0.8 to about 1:1.2, for example, about 1:0.9 to about 1:1.2, about 1:1 to about 1:1.2, about 1:1.1 to about 1:1.2, about 1:0.8 to about 1:1.1, about 1:0.8 to about 1:1, about 1:0.8 to about 1:0.9, or about 1:0.9 to about 1:1.

The catalyst may be any suitable compound which is able to catalyze the cross-linking reaction. Examples of a catalyst include, but are not limited to, one or more of dibutyl tin dilaurate, amine, or other alkali chemicals. In various embodiments, the catalyst is dibutyl tin dilaurate.

Subsequently, the two or more polyols may be cross-linked with the isocyanate cross-linking agent to form a matrix material, wherein the opacity agent is dispersed in the matrix material. The matrix material may form a polymeric base matrix to provide film forming properties, while opacity and/or aesthetic properties may be provided by the opacity agent.

Suitable weight ratios of the matrix material to the opacity agent have already been mentioned above. In various embodiments, weight ratio of the matrix material to the opacity agent is in the range of about 1:0.05 to about 1:3.

The opacity agent may be provided in the form of a dispersion, comprising about 5 wt % to about 75 wt % of the opacity agent, about 1 wt % to about 30 wt % of a dispersion agent, and about 10 wt % to about 90 wt % of a solvent, wherein sum of the opacity agent, the dispersion agent and the solvent totals 100 wt %. The dispersion containing the opacity agent may be formulated so as to be compatible with the matrix material, and for processability of the matrix material. Suitable solvents that may be used include, but are not limited to, acetone, propylene glycol monomethyl ether acetate, 1-methoxy-2-propanol acetate, or a combination thereof. In various embodiments, the solvent comprises propylene glycol monomethyl ether acetate. The same solvent as that used for dissolving the two or more polyols mentioned above may be used. The dispersion agent may function to disperse the opacity agent in the dispersion, and may be a surfactant. In various embodiments, the dispersion agent is a surfactant comprising pentanedioic acid, dimethyl ester and 2-methyoxy-1-methyl-ethylacetate.

In a third aspect, a method of coating an edge surface of an ophthalmic lens is provided. The method may comprise providing an ophthalmic lens comprising a first optical surface and an opposing second optical surface, wherein the first optical surface and the second optical surface are connected by an edge surface, and disposing a coating material on the edge surface of the ophthalmic lens as an edge coating. The edge coating may have a refractive index n₁ and the ophthalmic lens has a refractive index n₂, and wherein a) n₁ is greater than or equal to n₂, or b) n₁ is less than n₂, and (n₂−n₁) is 0.4 or less. As mentioned above, the refractive index of the edge coating and the refractive index of the ophthalmic lens may be such that refractive index of the edge coating n₁ is less than the refractive index of the ophthalmic lens, and difference between the refractive index of the ophthalmic lens and the refractive index of the edge coating is 0.4 or less, or less than 0.4, such as 0.3 or less, 0.2 or less, 0.1 or less, or 0.05 or less.

The coating material may, for example, be prepared by a method according to the second aspect. Suitable components of the coating material and method to prepare the coating material have already been discussed above.

The coating material may be disposed on the edge surface using a method selected from the group consisting of vacuum deposition, vapor deposition, sol-gel deposition, spin coating, dip coating, spray coating, flow coating, film laminating, sticker coating, roller coating, brush coating, painting, sputtering, casting, Langmuir-Blodgett deposition, laser printing, inkjet printing, screen printing, pad printing, and a combination thereof.

In a fourth aspect, use of a coating material having a refractive index n₁ to coat an edge surface of an ophthalmic lens having a refractive index n₂, wherein a) n₁ is greater than or equal to n₂, or b) n₁ is less than n₂, and (n₂−n₁) is 0.4 or less, is provided. As mentioned above, the refractive index of the edge coating and the refractive index of the ophthalmic lens may be such that refractive index of the edge coating n₁ is less than the refractive index of the ophthalmic lens, and difference between the refractive index of the ophthalmic lens and the refractive index of the edge coating is 0.4 or less, such as 0.3 or less, 0.2 or less, 0.1 or less, or 0.05 or less.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### Experimental Section

Myopia rings may be generated due to reflection of light from one or both of the optical surfaces and/or the edge surface. By minimizing or eliminating the reflection of light, visibility of myopia rings may be reduced or eliminated. The reflection of light from one or both of the optical surfaces and/or the edge surface may be carried out, for example, by one or more of (i) absorbing incident light on the interface of an ophthalmic lens and an edge coating; (ii) increasing the transmittance of incident light on the interface of an ophthalmic lens and an edge coating; (iii) increasing roughness of one or both of the optical surfaces and/or the edge surface.

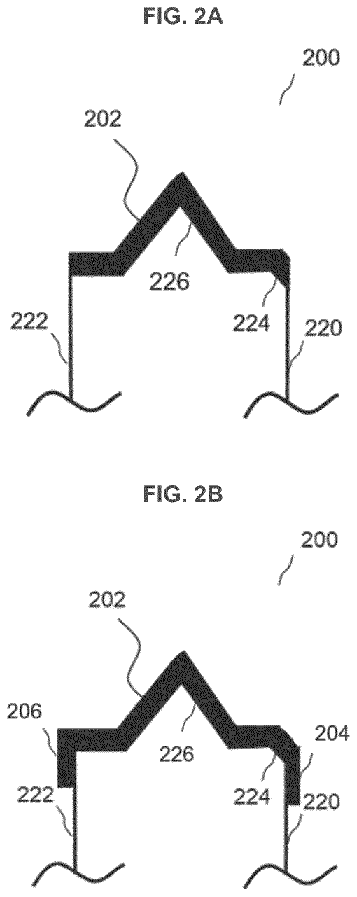

A coating material may be applied to an edge surface of the ophthalmic lens to absorb the light, so as to minimize reflection of light at the edge of the ophthalmic lens resulting from light that passes through the ophthalmic lens. As mentioned above, the edge surface of an ophthalmic lens may not be even as it may include sharp angles (grooves), right angles, and/or bevel (see, for example, FIG. 2A and FIG. 2B). The difference in geometry at the edge surface may cause difficulties in applying a coating homogeneously (same thickness throughout). To reduce variation in thickness of the edge coating, high viscosity may be necessary to minimize flowability thereby allowing the coating material to stick on the edge surface.

On the other hand, overflow of coating may be induced during application and a removal step has to be in place. During the removal step, the coating on the lens bevel and/or safety bevel may be affected easily, causing undesirable removal of coatings on the edge surface, particularly in case adhesion is too strong between the overflow and the optical surface, which renders the overflow difficult to be removed. In view of the above, there may be a compromise between adhesion of the coating material on the edge surface and ease of overflow removal from the optical surface(s), such as a compromise between the adhesion, and time and effort required to remove the overflow.

To achieve the above-mentioned objectives, and at the same time, having ability to process in a short time, specific chemistries, such as polyurethane, epoxy, polyurea-urethane, were chosen. Specific reactants, such as high performance polyols (dendritic polyols) with multiple reactive sites, was used to react with isocyanates forming highly crosslinked polyurethane, imparting the coating material with desired performances. Additionally, further polyols such as polycaprolactone-based polyols, which also contested in crosslinking with isocyanates, were used in the coating material formulation, so as to impart good mechanical properties to the edge coating within the short processing time frame.

The above-mentioned chemicals form a polymeric base matrix to provide film forming properties. Opacity and/or aesthetic properties, on the other hand, may be provided via colourants in the form of an ink solution. The colourants are mainly responsible for hiding the myopia rings and/or the white rings. The ink solution was formulated so as to be compatible with the polymeric base matrix and to ensure processability of the polymeric base matrix. Various colourants were introduced either using organic or inorganic pigments or dyes depending on target resultant colour.

Advantageously, a coating material disclosed herein was able to provide high opacity using only a single coat application. This single coat was sufficient to hide myopia rings as well as white rings. It also allowed easy removal of an overflow on one or both the first optical surface and the second optical surface of the ophthalmic lens.

In the experiments carried out, the whole process only required a maximum of 6 hours, after which the lenses were readily mounted onto the frame without any damage to the edge coating. Myopia rings were not visible on selected refractive index substrates. The coating was able to withstand water rinse, and allowed the lens to be cleaned with a wet cloth or a wiping paper.

### EXAMPLE 1

### Coating Formulation

Table 1 provides an exemplary list of components in a coating material according to embodiments.

TABLE 1
Exemplary list of components in coating material

| No. | Component |
|---|---|
| 1 | Dendritic polyol |
| 2 | Polycaprolactone-based polyol |
| 3 | Hexamethylene isocyanate trimer |
| 4 | Dibutyl Tin Dilaurate |
| 5 | Acetone |
| 6 | Propylene glycol monomethyl ether acetate |
| 7 | Surfactant comprising pentanedioic acid, |
| | dimethyl ester and 2-methyoxy-1-methyl-ethylacetate |
| 8 | Carbon black |

Table 2 is an exemplary weight percent of components.

TABLE 2
exemplary weight percentage range of components

| coating formulation | | |
|---|---|---|
| Component | Function | Wt % |
| Dendritic polyol | For adhesion, drying time, | 6 |
| | refractive index | |
| Polycaprolactone-based | For mechanical property, | 3 |
| polyol | adhesion, drying time, | |
| | leaching | |
| Hexamethylene isocyanate | Crosslinking agent | 5 |
| trimer | | |
| Dibutyl Tin Dilaurate | Catalyst | 1 |
| Acetone | Solvent, viscosity, drying | 40 |
| | time - volatility | |
| Propylene glycol | Co-solvent | 15 |
| monomethyl ether acetate | | |
| Black ink Dispersion | Opacity, particle size, | 30 |
| | index difference, | |
| | photostability | |

| | |
|---|---|
| Total | 100 |

TABLE 3
Exemplary black ink formulation and weight percentage range

| Black Ink Dispersion | | |
|---|---|---|
| Component | Component | Wt % |
| Propylene glycol monomethyl ether acetate | Solvent | 55 |
| Carbon black | Opacity Agent | 40 |
| Surfactant comprising pentanedioic acid, | Surfactant | 5 |
| dimethyl ester and 2-methyoxy-1 -methyl- | | |
| ethylacetate | | |
| Total | | 100 |

### EXAMPLE 2

### Exemplary Procedure to Prepare the Coating Material

Step 1: Dendritic polyol and acetone solvent were stirred at room temperature for 2 to 3 hours to prepare a solution.

Step 2: Polycaprolactone-based polyol and propylene glycol monomethyl ether acetate co-solvent were added into a conical flask with condenser, and heated at 50° C. for 2 to 4 hours until polycaprolactone-based polyol dissolved completely.

Step 3: The two solutions from Steps 1 and 2 were mixed under stirring for 2 to 3 hours.

Step 4: Black ink dispersion was added into the mixture and stirred for 1 hour.

Step 5: Hexamethylene isocyanate trimer as crosslinking agent was then added into the mixture and stirred for 15 to 20 minutes.

Step 6: Lastly, dibutyl tin dilaurate as catalyst was added and the resultant mixture was stirred for about 10 minutes.

### EXAMPLE 3

### Exemplary Procedure for Ink Preparation

The surfactant which comprises pentanedioic acid, dimethyl ester and 2-methyoxy-1-methyl-ethylacetate, was dissolved in propylene glycol monomethyl ether acetate as solvent. Carbon black was then added under constant stirring until a stable dispersion was obtained.

### EXAMPLE 4

### Exemplary Procedure for Coating Application

The coatings were applied on the edge of lens using a roller, brush, spray, spin or dip coating methods, while ensuring that all the edge facets were covered.

### EXAMPLE 5

### Exemplary Procedure for Curing Condition and Time

The coatings were cured at room temperature for 6 hours, or at 40° C. for 4 hours.

### EXAMPLE 6

### Exemplary Procedure for Overflow and Protective Layer Removal

The overflow coating over the optical surfaces of lens was removed using an adhesive tape. Care was taken not to damage the coated edge surface.

### EXAMPLE 7

### Performance Evaluation

1) Myopia Rings:

Criteria: Observation of intensity of myopia ring was made and graded accordingly on a scale from Grade 1 to Grade 5. Rating of Grade 5 was given if no myopia rings were observed, and Grade 1 was given if obvious myopia rings were observed.

Methodology: Myopia rings were observed visually from the front of the lenses. Observations were carried out at an angle of about 45 degrees to the plane of the optical surface at 4 different areas (left, right, top, bottom) of the ophthalmic lens after the lenses were mounted (refer to FIG. 7). Normal ambient light was used for the inspection.

2) White Rings

Criteria: Observation of perceived width of white ring from the front of lenses was made and graded accordingly on a scale from Grade 1 to Grade 5. Rating of Grade 5 was given if white ring was not present, and Grade 1 was given if there was no coverage of white ring.

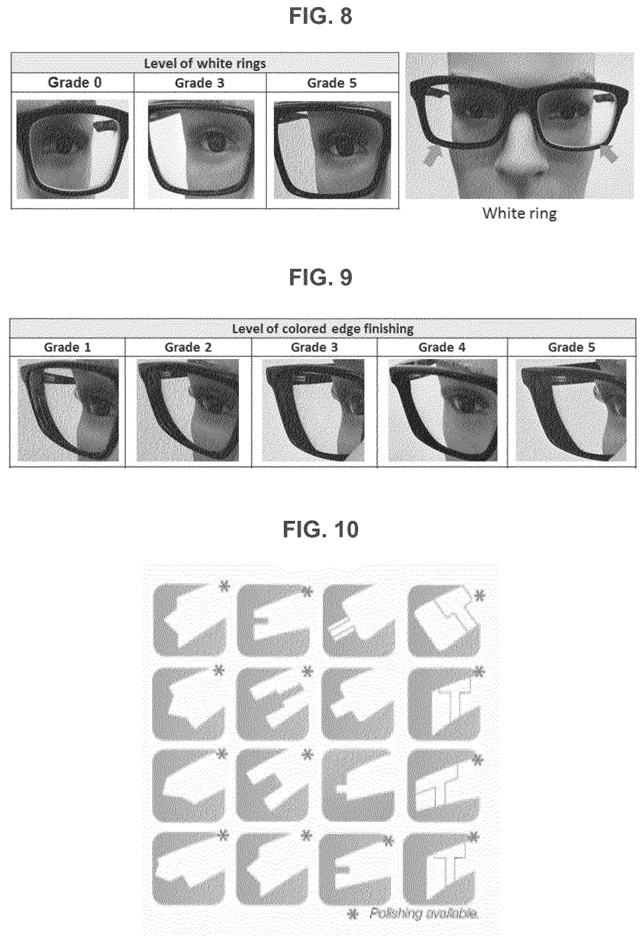

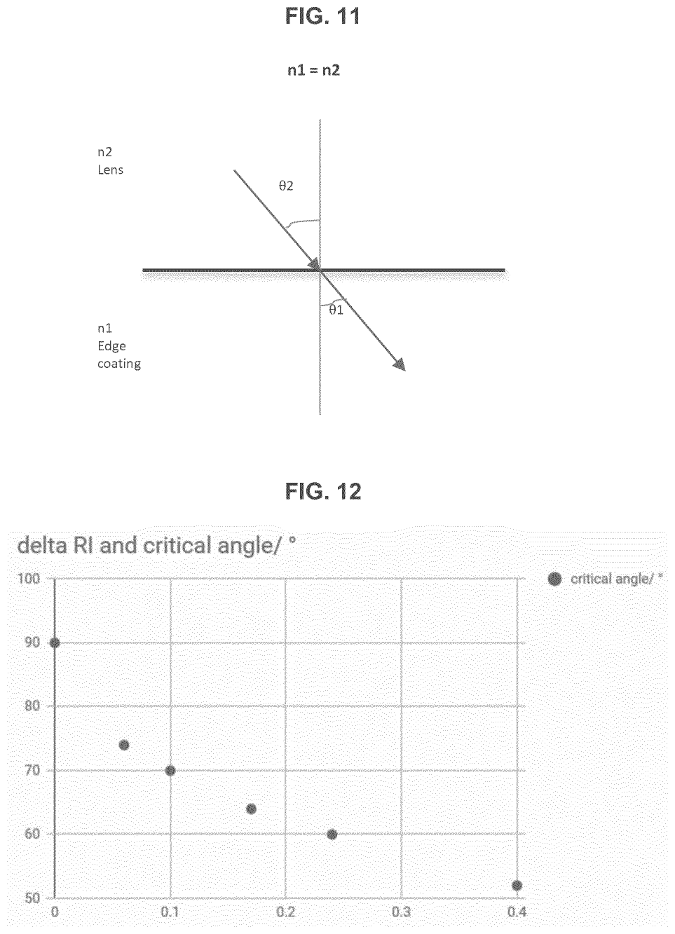

Methodology: White ring was observed visually from the front of the lenses. The frame may be slightly tilted during inspection to check for white spots/areas (refer to FIG. 8). Normal ambient light was used for the inspection.

3) Colour Edge Finishing

Criteria: Observation of visibility and regularity of white/grey patches not covered by coating, and whether coverage on Cc and Cx surfaces is 0%. Level of grading was characterized from Grade 1 to 5, with rating of Grade 5 given for the best level of finishing.

Methodology: Myopia rings were observed visually from the front of the lenses. Observations were carried out at an angle of about 45 degrees with respect to plane of the optical surface, in 4 different areas (left, right, top, bottom) after mounting of lenses (refer to FIG. 9). Normal ambient light was used for the inspection.

4) Fading of Coloured Edge Over Time

Criteria: Visual inspection of myopia rings after an accelerated weathering process exposure of 40 hrs was compared with lenses not exposed.

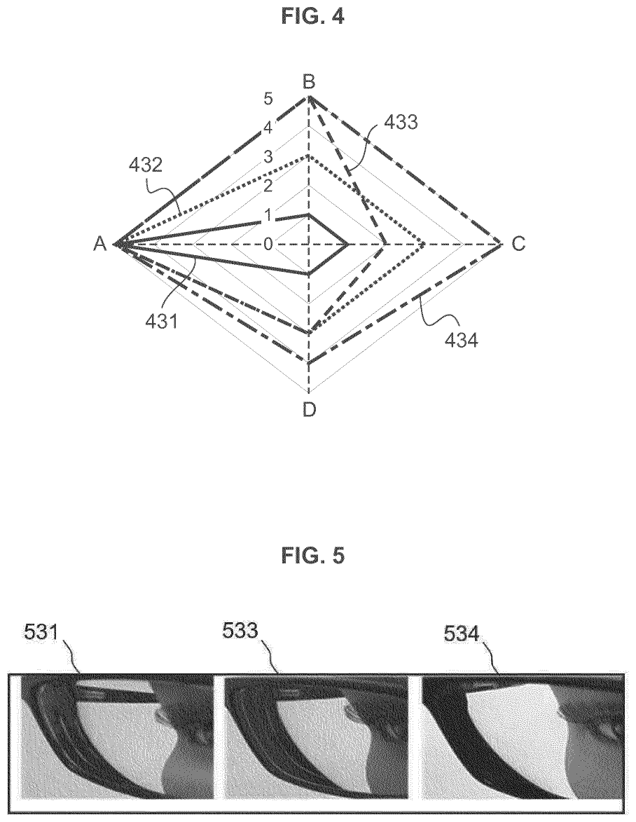

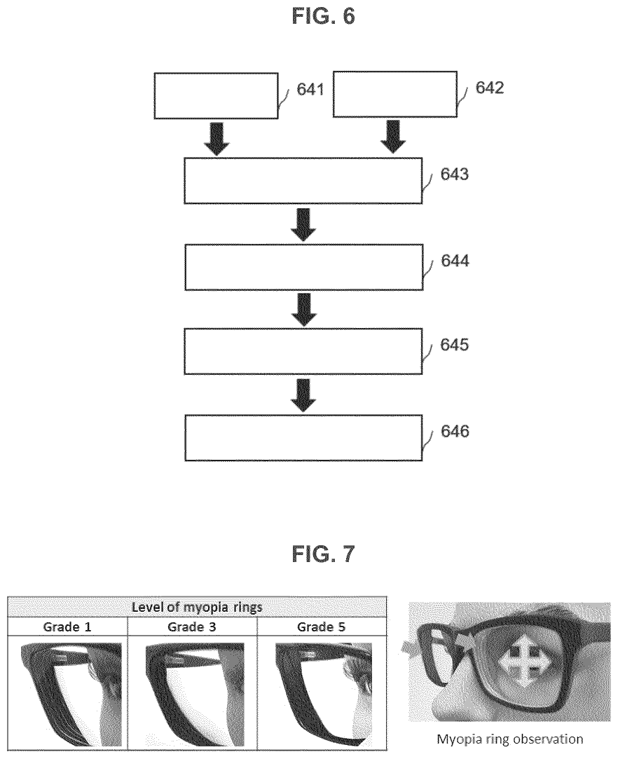

Methodology: Change in CE finishing grading was used to quantify. When it was graded as 5 in the spider chart in FIG. 4, it meant that the coating did not fade. The lenses tested just needed an observation before and after the accelerated weathering process exposure. It may be Grade 3/4/5 when it enter the accelerated weathering process exposure. As long as it did not change, it was considered photo stable.

5) Mounting Chipping Test

Lens was mounted and unmounted in frames for 3 times to check if the coating was chipped. Observation of CE finishing during each mounting and unmounting process was carried out.

6) Soap Ultrasonic Test

Lens with frames was immersed into the detergent soap solution and ultra-sonicated for 20 minutes.

### EXAMPLE 8

### Results of Coated Samples

### EXAMPLE 8.1

### Overflow Removal

Coatings were able to be coated with good flowability during the application process. Overflow removal performance on different layer/mask are shown in TABLE 4.

TABLE 4
Performance of removal of overflow on different layer/mask
Removal of overflow - Tape used: DS blue tape

| HMC | Ease of removal | 100% removal |
|---|---|---|
| Lens with hard coating (HC) only | N | N |
| Lens with HC and AR coating and | Y | Y |
| with Mixture X | | |
| Lens with HC and AR coating and | N | Y |
| without Mixture X | | |

(Legend: Y denotes Yes; N denotes No)

Overflow removal on lenses with Mixture X layer, which is a temporary protective material comprising a mixture of MgO and MgF₂), was easy and 100% overflow removal was possible when the Mixture X layer was wiped clean. In comparison, overflow removal on Lens with HC and AR coating and without Mixture X was difficult, although possible with multiple adhesive tape application.

### EXAMPLE 8.2

### Performance on Various Substrates

All of the data were obtained from the same coating formulation. Only the substrate was changed. Coating was carried out in a semi-manual state, and the equipment/coating/operator used were controlled to be as similar as possible to simulate the most similar conditions

TABLE 5
Performance of proposed coating on different substrates

| Substrate refractive index n₂ | 1.5 | 1.56 | 1.6 | 1.67 |
|---|---|---|---|---|
| CE finishing grading | 4 | 4 | 4 | 3 |
| Myopia rings grading | 5 | 5 | 4 | 3 |
| White rings grading | 5 | 5 | 5 | 5 |
| Mounting in 3 cycles | pass | pass | pass | pass |
| Fading test | pass | pass | pass | pass |
| Soap test | pass | pass | pass | pass |

The performance results with the rating on Grade are shown in TABLE 5.

Overall coloured edge performance includes the coloured edge finishing, myopia rings and white rings, each of which have already been described above. These parameters may be affected by the coating thickness in that a higher thickness may achieve high opacity, which in turn requires a much high coating viscosity.

The observation of myopia rings is of difference on different substrates. Myopia ring was observed to change with a different refractive index used. Coating gives a better myopia ring grading on 1.5 followed by 1.6 and 1.67.

Myopia rings were not visible on substrates with refractive index of 1.5 and 1.56. A grey faint line was observed on substrates with refractive index of 1.6 and 1.67, with the substrate having refractive index of 1.67 having a thicker grey area. This difference in myopia ring visibility may be caused by differences in refractive index of the substrate.

White ring suppression is achievable if surface was covered by coating. Adhesion plays an important role by preventing chipping of the coating to occur during the mounting and overflow removal process. All the lenses tested passed the mounting and unmounting cycles (3 cycles).

No colour changed after having been exposed under accelerated weathering process exposure for 80 hours and no colour leaching was observed during soap test.

### EXAMPLE 9

### Discussion on Refractive Index of Ophthalmic Lens

Myopia rings may be caused by total internal reflection when light travels from the lens edge to the air gap between the lens and the frame. This is particularly true at the lens edges, which, oftentimes, have been shaped in order to be fitted into the frame. FIG. 10 shows some examples of lens edge profiles.

Situations as to how refractive index of edge coating may be used to control visibility of myopia rings are detailed below.

In the following discussion, n₁ denotes refractive index of edge coating, and n₂ denotes refractive index of the ophthalmic lens.

Situation 1: Refractive Index of Edge Coating, n₁, is the Same as Refractive Index of the Ophthalmic Lens, n₂ (n₁=n₂)

In the first situation, an opaque coating with a refractive index n₁, which is the same as the refractive index of the lens n₂, is deposited on the edge of the lens. The abrupt change in refractive index at the lens edge-air interface is levelled by the colour-edge coating, as the light does not “see” or encounter a big difference in refractive index between the lens and the opaque ‘colour-edge’ coating. Hence, the light is able to traverse from the lens to the colour-edge coating with minimal refraction and/or reflection.

In embodiments wherein the ‘colour-edge’ coating is opaque or almost opaque, the coating is able to absorb at least part of, if not all, the light arriving from the lens, and this results in attenuation of the light, mathematically represented by the imaginary part of the refractive index: n=n+ik, where n is complex refractive index, n is refractive index, i is the square root of −1, and k is the absorption index.

The larger the attenuation of light, the higher the imaginary function of the refractive index. Visually, this translates into less visible myopia rings. When this happens, both total internal reflection (TIR) and refraction may be reduced or eliminated.

If n₁=n₂, critical angle for TIR=sin⁻¹(1)=90°. This means that total internal reflection does not take place.

In cases where the colour-edge coating is not thick enough or not absorbent enough to attenuate all the light, total internal reflection may occur at the air-colour edge coating interface. Nevertheless, even if the critical angle condition is fulfilled, the light may be reflected back into the absorbent colour-edge coating, which may lead to further attenuation of the light.

Situation 2: Refractive Index of Edge Coating, n₁, is Less Than Refractive Index of the Ophthalmic Lens, n₂ (n₁<n₂)

If refractive index of the colour-edge coating is lower than that of the lens, the larger the difference in index of refraction between the ‘colour-edge’ coating and the lens, the higher the propensity for total internal reflection (TIR) to occur due to reduced critical angle, and hence less attenuation of myopia rings possible by the absorptive colour-edge coating.

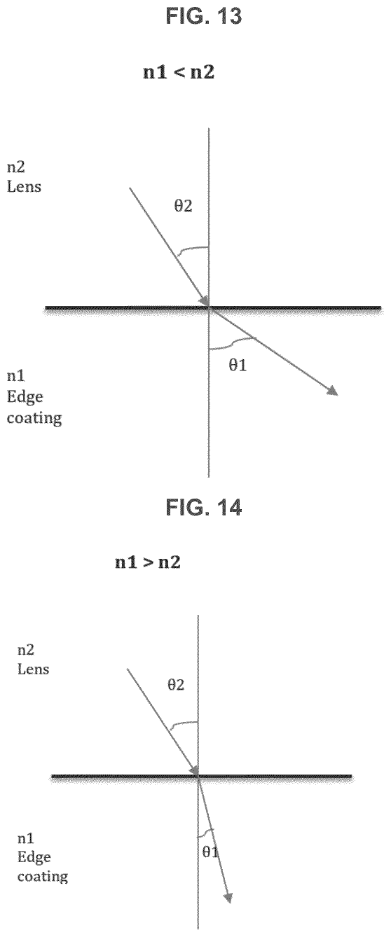

If n₁=1.5 and n₂=1.56, then critical angle for TIR=sin⁻¹(1.5/1.56)=74°. This translates into high tolerance for TIR. As shown in FIG. 13 where n₁<n₂, and n₁=1.5 and n₂=1.56 as an example, then the critical angle is 74°, which means when θ₂ reaches 74°, θ₁=90°, the total internal reflection occurs when θ₂>74°.

If n₁=1.5 and n₂=1.6, then critical angle for TIR=sin⁻¹(1.5/1.6)=70°. There is difference observed by trained eyes.

If n₁=1.5 and n₂=1.67, then the critical angle for TIR=sin⁻¹(1.5/1.67)=64°. There is difference observed by trained eyes.

If n₁=1.4 and n₂=1.8, which means the difference between n₁ and n₂ is up to 0.4, then the critical angle for TIR reaches 51°. This translates into higher probability of occurrence of TIR. When this happens, both total internal reflection and refraction may not be eliminated.

FIG. 12 shows the relationship between critical angle and delta refractive index (RI) according to the examples described above.

Situation 3: Refractive Index of Edge Coating, n₁, is Greater than Refractive Index of the Ophthalmic Lens, n₂ (n₁>n₂)

If the refractive index of the colour-edge coating is higher than that of the lens, for example, when TiO₂ nanoparticles are incorporated into the coating material, light may be able to pass from the lower index medium (lens) to higher index medium (colour-edge coating) by regular refraction of light without experiencing total internal reflection. In this case, myopia rings will not be observed either.

When this happens, total internal reflection may be eliminated but not refraction.

### EXAMPLE 10

### Other Experimental Variables

On the topic of attenuation of light by absorption of the colour-edge coating, other experimental variables, for example, type of coating method, thickness of the coating, and colour of the coating (in cases wherein a non-black coating is used) may alter attenuation of light and hence alter the hiding power, or effectiveness of the colour-edge coating.

For example, an edge coating having the same refractive index as the ophthalmic lens may result in less attenuation of myopia rings, if the coating material is less viscous, or does not spread well and/or leaves gaps during drying, or the resultant coating is thinner, as coating gaps or incomplete attenuation may occur with such coatings, hence rendering some myopia rings still visible even after coating.

In addition or apart from the above, if colours other than black are used, the attenuation power may also be different, since pigments of a different colour may have a different refractive index than the carbon black pigment (possibly also due to a different chemistry). Even between two colours wherein the refractive index is the same, pigments of a darker colour may have a higher propensity for absorption. This may result in increase in amount of light that is attenuated, and may translate visually to a colour-edge coating of better performance.

White ring suppression is achievable if surface was covered by coating. Adhesion plays an important role by preventing chipping of the coating to occur during the mounting and overflow removal process. All the lenses tested passed the mounting and unmounting cycles (3 cycles).

No colour changed after having been exposed under accelerated weathering process exposure for 80 hours and no colour leaching was observed during soap test.

Various embodiments disclosed herein may be used on and for lenses that require coating on the edges, in particular to eliminate myopia rings and white rings through introduction of an opaque coating on the edge of the lens.

Numerous prototypes with different optical designs (myopic, hyperopic, PALs) have been produced.

Other applications may include use of a coating which has lubricating properties to ease the mounting of lenses onto spectacle frames as well as the use of a shock absorbing coating to prevent stress concentrations on lens edges to reduce crack formation.

Although representative processes and articles have been described in detail herein, those skilled in the art will recognize that various substitutions and modifications may be made without departing from the scope of what is described and defined by the appended claims.

1-11. (canceled)

12. An eyewear comprising an ophthalmic lens, the ophthalmic lens comprising a first optical surface and an opposing second optical surface, and an edge surface connecting the first optical surface and the opposing second optical surface, the ophthalmic lens further comprising a coating material disposed on the edge surface of the ophthalmic lens as an edge coating,
wherein the edge coating has a refractive index n₁ and the ophthalmic lens has a refractive index n₂, and wherein
a) n₁ is greater than or equal to n₂, or
b) n₁ is less than n₂, and (n₂−n₁) is 0.4 or less.

13. The eyewear according to claim 12, wherein a) n₁ is greater than or equal to n₂, or b) n₁ is less than n₂, and (n₂−n₁) is 0.3 or less.

14. The eyewear according to claim 12, wherein a) n₁ is greater than or equal to n₂, or b) n₁ is less than n₂, and (n₂−n₁) is 0.2 or less.

15. The eyewear according to claim 12, wherein a) n₁ is greater than or equal to n₂, or b) n₁ is less than n₂, and (n₂−n₁) is 0.1 or less.

16. The eyewear according to claim 12, wherein a) n₁ is greater than or equal to n₂, or b) n₁ is less than n₂, and (n₂−n₁) is 0.05 or less.

17. The eyewear according to claim 12, wherein the coating material comprises an opacity agent and a matrix material, the opacity agent is dispersed in the matrix material.

18. The eyewear according to claim 17, wherein weight ratio of the matrix material to the opacity agent is in the range of about 1:0.05 to about 1:3.

19. The eyewear according to claim 17, wherein the matrix material comprises a cross-linked polyurethane.

20. The eyewear according to claim 17, wherein the opacity agent comprises carbon black.

21. The eyewear according to claim 12, wherein the edge coating has one or more of: a) a transmittance of less than 5%; b) an adhesion strength in the range of 1 N/mm² to 5 N/mm²; c) a pencil hardness in the range of 1H to about 4 H.

22. The eyewear according to claim 12, wherein n₁ is greater than n₂.

23. A method of manufacturing an eyewear, comprising providing an ophthalmic lens comprising a first optical surface and an opposing second optical surface, and an edge surface connecting the first optical surface and the second optical surface, and disposing a coating material on the edge surface of the ophthalmic lens as an edge coating,
wherein the edge coating has a refractive index n₁ and the ophthalmic lens has a refractive index n₂, and wherein
a) n₁ is greater than or equal to n₂, or
b) n₁ is less than n₂, and (n₂−n₁) is 0.4 or less.

24. The method according to claim 20, wherein n₁ is greater than n₂

25. Use of an ophthalmic lens in an eyewear, wherein the ophthalmic lens has a refractive index n₂ and further comprises a coating material disposed on an edge surface of the optical lens as an edge coating having a refractive index n₁, wherein
a) n₁ is greater than or equal to n₂, or
b) n₁ is less than n₂, and (n₂−n₁) is 0.4 or less.
